(19) United States
(12) Patent Application Publication
(10) Pub. No.: US 2011/0156545 A1
(43) Pub. Date: Jun. 30, 2011

(54) MOTOR DRIVE ASSEMBLY

(76) Inventors: Chao WEN, Shenzhen (CN); Xiao Ming Wang, Hong Kong (CN); Ling Li Liu, Harbin (CN); Nian He Qu, Shenzhen (CN); Yuan Jiang, Shenzhen (CN)

(21) Appl. No.: 12/982,596

(22) Filed: Dec. 30, 2010

(30) Foreign Application Priority Data
Dec. 30, 2009 (CN) 200910239657.2

(51) Int. Cl. H02K 23/66

(52) U.S. Cl. 310/68 B

(57) ABSTRACT

A motor drive assembly has a motor, a gearbox and a control module. The control module has a printed circuit board, flat contacts formed on the PCB and a micro control unit mounted to the PCB. The flat contacts are resiliently pressed by respective motor terminals to establish electrical connection. The micro control unit comprises a data processing unit for processing signals from a sensor such as Hall sensors and a analog drive unit for operating a relay that controls the electrical connection between the flat contacts and an external power supply.

### CROSS REFERENCE TO RELATED APPLICATIONS

This non-provisional patent application claims priority under 35 U.S.C. §119(a) from Patent Application No. 200910239657.2 filed in The People's Republic of China on Dec. 30, 2009.

### FIELD OF THE INVENTION

This invention relates to a motor drive assembly comprising a motor and a gearbox. The motor drive assembly has a particular application for raising and lowering windows of a vehicle.

### BACKGROUND OF THE INVENTION

FIG. 1 illustrates a traditional motor drive assembly for raising and lowering windows of a vehicle. The motor drive assembly comprises a motor 10′, a gearbox 20′ fixed to the motor and a control module 30′. The gearbox 20′ comprises a worm gear driven by the motor 10′. The control module 30′ is fixed with the motor 10′ and the gearbox 20′. The control module 30′ comprises an L shaped printed circuit board (PCB) 31′. The PCB 31′ comprises a first part disposed near to the motor 10′ and extending axially and a second part arranged inside the gearbox 20′ and extending perpendicularly to the first part to form an “L”. An L shaped connector 33′ is mounted to the PCB 31′ at the portion where the first part and the second part meet. Current is supplied to the motor 10′ by the connector 33′. The connector 33′ increases the size of the PCB assembly and the PCB assembly increases the size of the motor.

FIG. 2 is a circuit diagram of the control module 30′. The control module 30′ comprises two micro integrated chips (IC). The first IC (labeled MCU) processes digital data and outputs a control signal. The first IC is not capable of driving relays. The second IC (labeled Analog chip) is an analog chip, comprising: a voltage adjusting circuit, a relay drive circuit, a current detection circuit, etc. The second IC receives signals via the serial peripheral interface bus (labeled SPI bus) to drive the relay. The current detection circuit is used to detect current variation to trigger an anti-pinching function. It is difficult to reduce the size of the motor drive assembly due to the number of parts and the size of the PCB.

### SUMMARY OF THE INVENTION

Hence there is a desire for an improved motor drive assembly which is smaller and/or has less parts.

Accordingly, in one aspect thereof, the present invention provides a motor drive assembly comprising: a control module; a motor controlled by the control module; and a gearbox mounted to the motor, the gearbox comprising a gear train driven by the rotor shaft of the motor, wherein the control module comprises: a printed circuit board at least partially received inside the gearbox; a signal magnet fixed to the rotor shaft; a rotation sensor mounted on the printed circuit board near to the signal magnet for detecting rotation of the rotor shaft; a relay for selectively connecting electrical power to the motor; and a single micro control unit mounted on the printed circuit board to receive and process signals from the rotation sensor and to operate the relay.

Preferably, the micro control unit comprises a data processing unit for receiving and processing the signals from the rotation sensor and an analog drive unit for operating the relay.

Preferably, the printed circuit board has flat contacts formed thereon for feeding power to the motor and the relay controls the electrical connection between the flat contacts and an external power supply.

Preferably, the flat contacts are resiliently pressed by respective motor terminals to make an electrical connection there with.

Preferably, two grooves are formed inside the gearbox for receiving two opposite edges of the printed circuit board.

Preferably, at least one step is formed in one edge of the printed circuit board and the rotation sensor is arranged on a portion of the printed circuit board that has a reduced dimension due to the step.

According to a second aspect, the present invention provides a motor drive assembly comprising a motor, a control module for controlling the motor, and a gearbox mounted to the motor, the gearbox comprising a worm gear driven by the rotor shaft of the motor, wherein the control module comprises a printed circuit board and two flat contacts formed on the printed circuit board, the two flat contacts being resiliently pressed by respective motor terminals to make electrical contact.

Preferably, the two flat contacts are located on opposite surfaces of the printed circuit board.

Preferably, the printed circuit board is disposed substantially inside the gearbox and is substantially parallel to the rotor shaft.

Preferably, at least one step is formed in one side of the printed circuit board.

Preferably, two grooves are formed inside the gearbox and respective edges of the printed circuit board are disposed in the grooves.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 illustrates an axial cross section of a traditional motor drive assembly;

FIG. 2 is a circuit diagram of a control module of the motor drive assembly of FIG. 1;

FIG. 3 illustrates a motor drive assembly according to a preferred embodiment of the present invention;

FIG. 4 illustrates an axial cross section of the motor drive assembly of FIG. 3;

FIG. 5 is an exploded view of the motor drive assembly of FIG. 3;

FIG. 6 illustrates a gearbox and a printed circuit board of the motor drive assembly of FIG. 3;

FIG. 7 illustrates the printed circuit board and a motor of the motor drive assembly of FIG. 3;

FIG. 8 shows the printed circuit board; and

FIG. 9 is a circuit diagram of the control module of the motor drive assembly of FIG. 3.

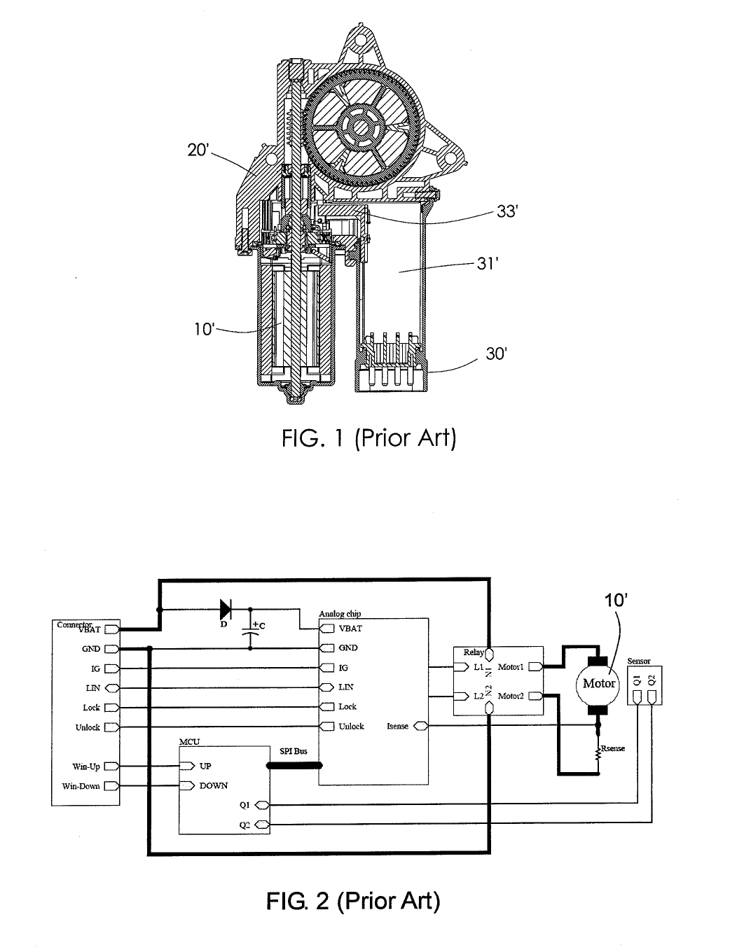

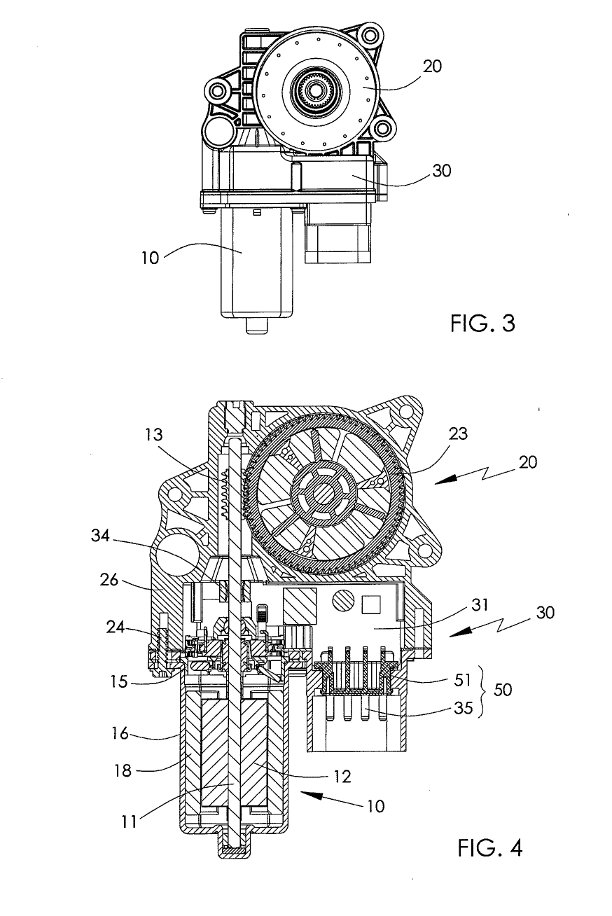

### DETAILED DESCRIPTION OF THE PREFERRED EMBODIMENTS

The motor drive assembly according to the preferred embodiment comprises a motor 10, a gearbox 20 and a control module 30. The motor 10 is a permanent magnet direct current (PMDC) motor, comprising a stator and a rotor rotatably mounted to the stator. The stator comprises a housing 16, permanent magnets 18 fixed to an inner surface of the housing 16 and an end cap 15 fixed to the opening of the housing 16. The rotor comprises a rotor shaft 11, a rotor core 12 fixed to the rotor shaft 11, windings wound about teeth of the rotor core 12 and a commutator fixed to the rotor shaft 11 adjacent to the rotor core 12. The rotor is rotatably mounted to the stator with the rotor shaft 11 supported by bearings fixed to the stator. A worm 13 is fixed to and rotates with the rotor shaft 11. Brushes are disposed on the end cap 15. The brushes are in sliding contact with the commutator to supply current to the rotor windings.

The gearbox 20 is mounted to one end of the motor 10. The gearbox 20 comprises a housing 26 having an opening 28 (refer to Fig .5) facing the motor 10. A gear train in the form of a worm wheel 23 drives an output shaft of the gearbox. The rotor shaft 11 extends into the opening 28 with the worm 13 disposed inside the gearbox in mesh with the worm gear 23 to drive the output shaft of the gearbox 20.

The control module 30 comprises a housing 36, a PCB 31, a rotation sensor such as Hall sensors 32 mounted to the PCB 31, a connector 50 comprising terminals 35 fixed to the PCB 31 and a base 51 to support the terminals, two flat contacts 38 arranged on the PCB 31, a single micro control unit (IDC) 45 mounted to the PCB 31, a capacitor 46 mounted to the PCB 31, a relay 48 mounted to the PCB 31, and a signal magnet 34 fixed to the rotor shaft 11. The signal magnet 34 is arranged between the end cap 15 and the worm 13 and rotates with the rotor shaft 11. Most of the PCB 31 is received inside the opening 28 of the gearbox and preferably the entire PCB 31 is received inside the opening 28. The PCB 31 extends in a plane that is substantially parallel to the rotor shaft 11. Preferably, the longest side of the PCB 31 extends in a direction substantially perpendicular to the rotor shaft 11.

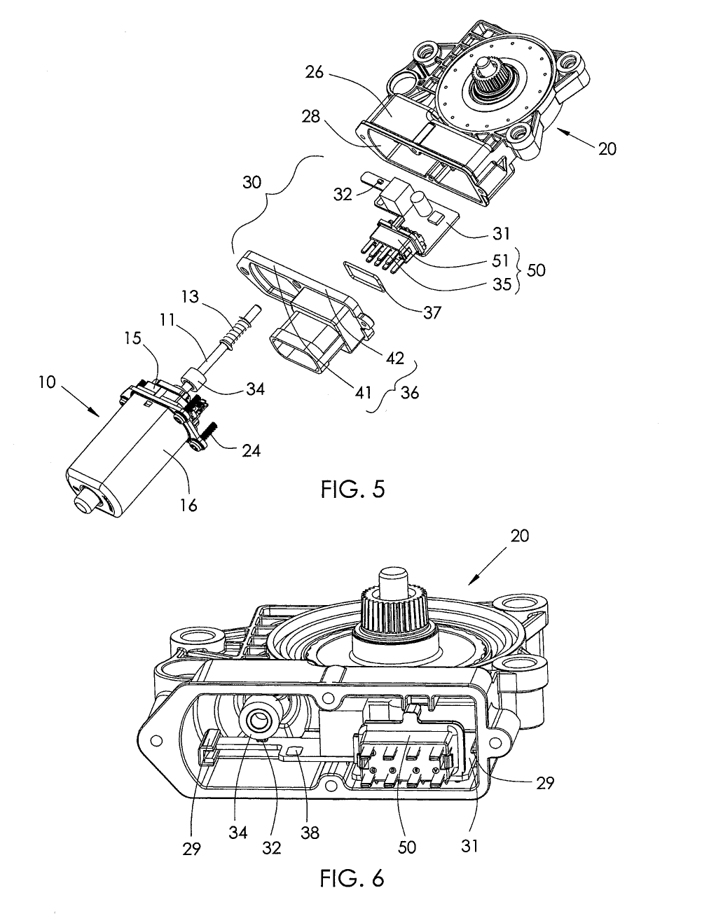

As shown in FIG. 6, a pair of grooves 29 is formed inside the opening 28, extending in the axial direction. Two opposite edges of the PCB 31 are received in respective grooves 29 and the PCB 31 is pressed inwardly into the opening 28. Preferably the PCB 31 is a slight press fit in the grooves 29 so that undesired movement of the PCB 31 is restricted. The Hall sensors 32 are disposed near to the signal magnet 34 to detect rotation of the signal magnet 34. The terminals 35 are embedded within the terminal base 51 and fixed to the PCB 31 by means of soldering. The terminals 35 are electrically connected to the micro control unit 45. The terminals 35 comprises power line terminals for supplying current to the electronic components and the motor and signal line terminals for receiving signals and commands from a user. As shown in FIG. 5 and FIG. 6, in this embodiment, the Hall sensors 32 are disposed on the left half of the PCB 31 and the terminals 35 are disposed on the right half of the PCB 31.

The housing 36 of the control module 30 is fixed to the opening 28 of the gearbox 20 to lock the PCB 31 inside the opening 28. The housing 36 comprises a first portion 41 sandwiched by the motor housing 16 and the gearbox housing 26, and a second portion 42 that is fixed to the gearbox housing 26 by means of screws without being sandwiched by the motor housing 16. The motor housing 16 and the gearbox housing 26 are lock together by means of screws 24. The second portion 42 is a hollow cylinder and supports the terminal base 51. An elastic washer 37 is arranged between the terminal base 51 and the second portion 42 to make the joint water proof. Preferably, the first portion 41 is slightly flexible especially at the interfaces that directly contact the motor housing 16 and gearbox housing 26 to improve resistance to water ingress via these joints. Optionally, additional washers or seal members may be used to make the joints water proof.

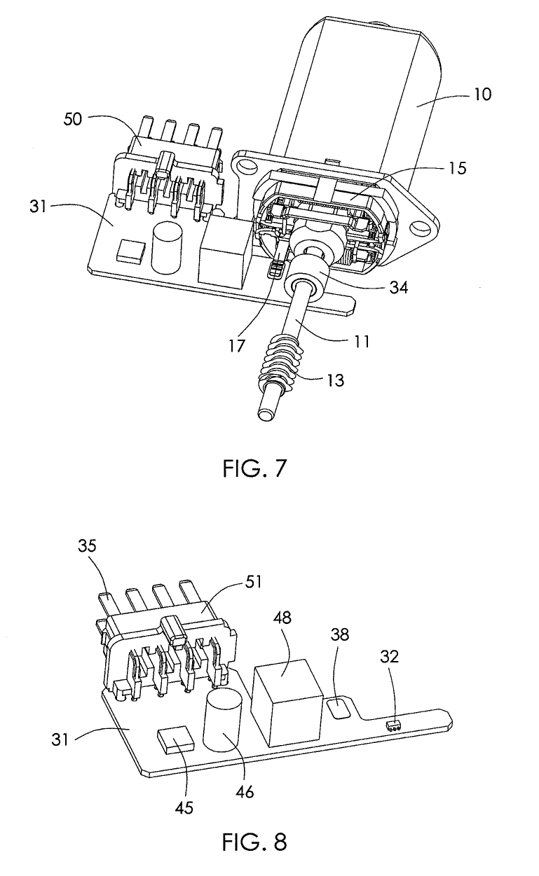

Referring to FIG. 6 and FIG. 7, the two flat contacts 38 are formed on respective surfaces of the PCB 31. The motor 10 comprises two resilient terminals that press the contacts 38 when the motor drive assembly is assembled, to establish electrical connection with the motor. By using the flat contacts 38, the traditional L shaped connector is not required and the structure of the motor drive assembly is simplified. Optionally, the two contacts 38 can be arranged on one surface of the PCB 31. Compared with the traditional motor drive assembly, the motor drive assembly of the invention is more compact since most of the PCB 31 is received inside the gearbox 20. This is possible due to the use of the single micro control unit and elimination of the internal L shaped connector.

As shown in FIG. 7 and FIG. 8, in this embodiment, the PCB 31 comprises three steps in one side or edge. The Hall sensors 32 are arranged at the first step where the PCB 31 has its smallest axial dimension. The flat contacts 38 and the relay 48 are arranged at the second step. The terminals 35, the micro control unit 45 and the capacitor 46 are arranged at the third step where the PCB 31 has its largest axial dimension.

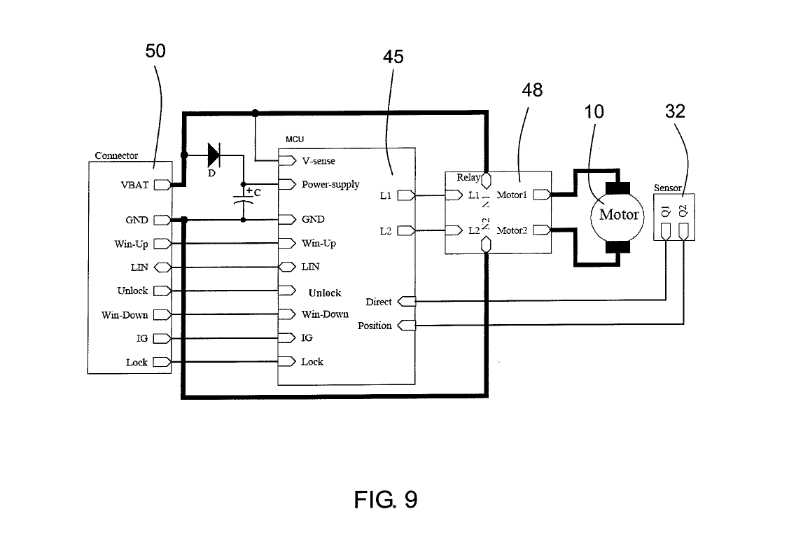

Referring to FIGS. 7 to 9, the micro control unit 45 comprises a data processing unit and an analog drive unit. The micro control unit 45 is electrically connected to the Hall sensors 32, receiving and processing the signals from the Hall sensor 32 by the data processing unit, to determine the position, speed and acceleration of a driven member such as a window according to the signals. The micro control unit 45 is also electrically connected to the relay 48 and operates the relay 48 by the analog drive unit. The electrical connection between the flat contacts 38 and an external power supply is controlled by the relay 48. Compared with the traditional control module using separated data processing IC and analog drive IC, the control module of this invention uses a single micro control unit, reducing the number of parts needed and reducing the size of the printed circuit board and thus allowing the size of the control module to be reduced.

The motor drive assembly is particularly suited to window lift drive applications. The micro control unit 45 determines whether and when to trigger the anti-pinching function according to the signals from the Hall sensors 32. For example, when a user wants to raise the window, the micro control unit 45 operates the relay 48 to connect the external power supply to the motor terminals and the motor 10 rotates in a first direction. If the window encounters an obstacle in the window path, the moving speed of the window as well as the rotational speed of the rotor shaft will vary from the expected value and the speed variation is detected by the Hall sensors 32. The micro control unit 45 will trigger the anti pinching response according to the signals from the Hall sensor 32. In this way, the traditional current detection circuit is not required to detect the presence of obstacles.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. A motor drive assembly comprising: a control module; a motor controlled by the control module; and a gearbox mounted to the motor, the gearbox comprising a gear train driven by a rotor shaft of the motor,
wherein the control module comprises: a printed circuit board at least partially received inside the gearbox; a signal magnet fixed to the rotor shaft; a rotation sensor mounted on the printed circuit board near to the signal magnet for detecting rotation of the rotor shaft; a relay for selectively connecting electrical power to the motor; and a single micro control unit mounted on the printed circuit board to receive and process signals from the rotation sensor and to operate the relay.

2. The motor drive assembly of claim 1, wherein the micro control unit comprises a data processing unit for receiving and processing the signals from the rotation sensor and an analog drive unit for operating the relay.

3. The motor drive assembly of claim 1, wherein the printed circuit board has flat contacts formed thereon for feeding power to the motor and the relay controls the electrical connection between the flat contacts and an external power supply.

4. The motor drive assembly of claim 3, wherein the flat contacts are resiliently pressed by respective motor terminals to make an electrical connection there with.

5. The motor drive assembly of claim 1, wherein two grooves are formed inside the gearbox for receiving two opposite edges of the printed circuit board.

6. The motor drive assembly of claim 1, wherein at least one step is formed in one edge of the printed circuit board and the rotation sensor is arranged on a portion of the printed circuit board that has a reduced dimension due to the step.

7. A motor drive assembly comprising: a motor, a control module for controlling the motor, and a gearbox mounted to the motor, the gearbox comprising a worm gear driven by a rotor shaft of the motor,
wherein the control module comprises a printed circuit board and two flat contacts formed on the printed circuit board, the two flat contacts being resiliently pressed by respective motor terminals to make electrical contact.

8. The motor drive assembly of claim 7, wherein the two flat contacts are located on opposite surfaces of the printed circuit board.

9. The motor drive assembly of claim 7, wherein the printed circuit board is disposed substantially inside the gearbox and is substantially parallel to the rotor shaft.

10. The motor drive assembly of claim 7, wherein at least one step is formed in one side of the printed circuit board.

11. The motor drive assembly of claim 7, wherein two grooves are formed inside the gearbox and respective edges of the printed circuit board are disposed in the grooves.
